(19) United States
(12) Patent Application Publication
(10) Pub. No.: US 2025/0133530 A1
(43) Pub. Date: Apr. 24, 2025

(54) INFORMATION PROCESSING SYSTEM, INFORMATION PROCESSING APPARATUS, INFORMATION PROCESSING METHOD, AND STORAGE MEDIUM

(71) Applicant: NEC Corporation, Minato-ku, Tokyo (JP)

(72) Inventors: Sawaka SEKI, Tokyo (JP); Hiroaki AMINAKA, Tokyo (JP); Masaru YANAI, Tokyo (JP); Motoharu OHTAKE, Tokyo (JP); Hideki MURAMATSU, Tokyo (JP); Yoshikatsu NIWA, Tokyo (JP); Noritsugu YAMANAKA, Tokyo (JP); Natsumi YOKOYAMA, Tokyo (JP); Kosei KOBAYASHI, Tokyo (JP); Hideki KIKKAWA, Tokyo (JP)

(73) Assignee: NEC Corporation, Minato-ku, Tokyo (JP)

(21) Appl. No.: 18/836,053

(22) PCT Filed: Feb. 14, 2022
(86) PCT No.: PCT/JP2022/005667

§ 371 Date: Aug. 6, 2024

(51) Int. Cl. H04W 64/00; H04B 17/318

(52) U.S. Cl. CPC H04W 64/00; H04B 17/318

(57) ABSTRACT

To determine the environment of a radio channel even in a case where the distance between wireless communication apparatuses varies, an information processing system (1) includes: obtaining means (11) for obtaining distance information that indicates a distance between a first wireless communication apparatus and a second wireless communication apparatus that directly perform communication with each other through a radio channel, and quality information that is information associated with quality of the communication; decision means (12) for deciding an algorithm for determining the environment of the radio channel with reference to the distance information; and determination means (13) for determining the environment of the radio channel by using the quality information and the algorithm decided by the decision means (12).

### TECHNICAL FIELD

The present invention relates to a technique for determining the environment of a radio channel.

### BACKGROUND ART

There is known a technique for ascertaining the environment of a channel between wireless communication apparatuses based on the quality of signals used in wireless communication between the wireless communication apparatuses. For example, Patent Literature 1 discloses that when the amount of attenuation of a signal is not less than a threshold, it is determined that the channel is in a rain condition.

### CITATION LIST

### Patent Literature

[Patent Literature 1]

International Publication No. WO 2007/144960

### SUMMARY OF INVENTION

### Technical Problem

On the other hand, mobile objects capable of performing wireless communication, such as drones, have been used in recent years. When wireless communication apparatuses move, it is difficult to ascertain the environment of the radio channel based on the signal quality. Even with the technique disclosed in Patent Literature 1, it is still difficult to ascertain the environment of the radio channel in a case where the distance between wireless communication apparatuses varies.

An example aspect of the present invention has been made in view of this problem, and an example object thereof is to provide a technique capable of determining the environment of a radio channel even in a case where the distance between wireless communication apparatuses varies.

### Solution to Problem

An information processing system in accordance with an example aspect of the present invention includes: obtaining means for obtaining distance information that indicates a distance between a first wireless communication apparatus and a second wireless communication apparatus that directly perform communication with each other through a radio channel, and quality information that is information associated with quality of the communication; decision means for deciding an algorithm for determining an environment of the radio channel with reference to the distance information; and determination means for determining the environment of the radio channel by using the quality information and the algorithm decided by the decision means.

An information processing apparatus in accordance with an example aspect of the present invention includes: obtaining means for obtaining distance information that indicates a distance between a first wireless communication apparatus and a second wireless communication apparatus that directly perform communication with each other through a radio channel, and quality information that is information associated with quality of the communication; decision means for deciding an algorithm for determining an environment of the radio channel with reference to the distance information; and determination means for determining the environment of the radio channel by using the quality information and the decided algorithm.

An information processing method in accordance with an example aspect of the present invention includes: obtaining distance information that indicates a distance between a first wireless communication apparatus and a second wireless communication apparatus that directly perform communication with each other through a radio channel, and quality information that is information associated with quality of the communication; deciding an algorithm for determining an environment of the radio channel with reference to the distance information; and determining the environment of the radio channel by using the quality information and the algorithm decided by the decision means.

A program in accordance with an example aspect of the present invention is a program for causing a computer to carry out: an obtaining process of obtaining distance information that indicates a distance between a first wireless communication apparatus and a second wireless communication apparatus that directly perform communication with each other through a radio channel, and quality information that is information associated with quality of the communication; a decision process of deciding an algorithm for determining an environment of the radio channel with reference to the distance information; and a determination process of determining the environment of the radio channel by using the quality information and the algorithm decided in the decision process.

### Advantageous Effects of Invention

According to an example aspect of the present invention, it is possible to determine the environment of the radio channel even in a case where the distance between the wireless communication apparatuses varies.

### BRIEF DESCRIPTION OF DRAWINGS

FIG. 1 is a block diagram illustrating the configuration of an information processing system in accordance with a first example embodiment.

FIG. 2 is a block diagram illustrating the configuration of an information processing apparatus in accordance with the first example embodiment.

FIG. 3 is a flowchart illustrating the flow of an information processing method in accordance with the first example embodiment.

FIG. 4 is a block diagram illustrating the configuration of an information processing system in accordance with a second example embodiment.

FIG. 5 is a flowchart illustrating the flow of an information processing method in accordance with the second example embodiment.

FIG. 6 is a flowchart illustrating the flow of an information processing method in accordance with the second example embodiment.

FIG. 7 is a flowchart illustrating the flow of an information processing method in accordance with the second example embodiment.

FIG. 8 is a block diagram illustrating the configuration of an information processing system in accordance with a third example embodiment.

FIG. 9 is a diagram illustrating a specific example of a monitored path in accordance with the third example embodiment.

FIG. 10 is a diagram illustrating a specific example of a monitored area in accordance with the third example embodiment.

FIG. 11 is a block diagram illustrating the configuration of a computer that functions as each of the information processing apparatuses in accordance with the example embodiments.

### EXAMPLE EMBODIMENTS

### First Example Embodiment

A first example embodiment of the present invention will be described in detail with reference to the drawings. The present example embodiment is an embodiment serving as a basis for example embodiments described later.

### Configuration of Information Processing System

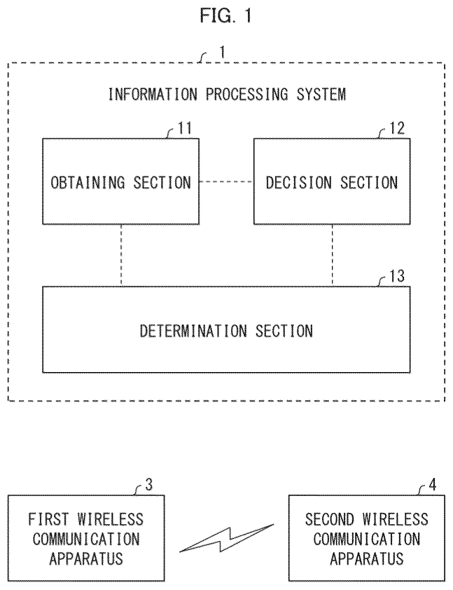

The following description will discuss the configuration of an information processing system 1 in accordance with the present example embodiment with reference to FIG. 1. FIG. 1 is a block diagram illustrating the configuration of the information processing system 1. The information processing system 1 includes an obtaining section 11, a decision section 12, and a determination section 13.

### Obtaining Section 11

The obtaining section 11 obtains: distance information that indicates the distance between a first wireless communication apparatus 3 and a second wireless communication apparatus 4 that directly perform communication with each other through a radio channel; and quality information that is information associated with the quality of the communication. Here, the first wireless communication apparatus 3 and the second wireless communication apparatus 4 directly perform communication with each other through a radio channel, and may be, for example, drones or unmanned aerial vehicles (UAVs). However, the first wireless communication apparatus 3 and the second wireless communication apparatus 4 are not limited to these examples, but may be any other apparatuses that performs wireless communication. One or both of the first wireless communication apparatus 3 and the second wireless communication apparatus 4 may each include a moving mechanism that moves the wireless communication apparatus to which the moving mechanism is provided. Hereunder, in a case where the first wireless communication apparatus 3 and the second wireless communication apparatus 4 do not need to be distinguished between each other, these apparatuses may also be referred to as “wireless communication apparatuses”.

The radio channel is a channel for use in wireless communication performed between the first wireless communication apparatus 3 and the second wireless communication apparatus 4, and may be, for example, a channel of Wi-Fi (registered trademark), Bluetooth (registered trademark), cellular Vehicle-to-X (V2X) PC5 communication, or ProSe (D2D) communication. However, the radio channel is not limited to these examples, and may be a channel for any other wireless communication protocol. As an example, the first wireless communication apparatus 3 and the second wireless communication apparatus 4 exchange their position information with each other by wireless communication. However, the information exchanged between the first wireless communication apparatus 3 and the second wireless communication apparatus 4 by wireless communication is not limited to the position information, and any other information may be exchanged between the first wireless communication apparatus 3 and the second wireless communication apparatus 4 by wireless communication.

There may be a case where the distance between the first wireless communication apparatus 3 and the second wireless communication apparatus 4 varies because one or both of the first wireless communication apparatus 3 and the second wireless communication apparatus 4 move. Each of the first wireless communication apparatus 3 and the second wireless communication apparatus 4 may be made to move by the moving mechanism provided thereto, and in a case where the wireless communication apparatus is provided with no moving mechanism, the wireless communication apparatus may be made to move by an external moving mechanism provided externally to the wireless communication apparatus. An administrator or the like of the wireless communication apparatus may move the wireless communication apparatus.

As an example, the obtaining section 11 may calculate the distance information that indicates the distance between the first wireless communication apparatus 3 and the second wireless communication apparatus 4 on the basis of the position information of the first wireless communication apparatus 3 and the position information of the second wireless communication apparatus 4. As an example, the obtaining section 11 may receive, from the first wireless communication apparatus 3 and the second wireless communication apparatus 4, through a communication channel, the position information of each wireless communication apparatus determined by the global navigation satellite system (GNSS). It should be noted that the present example embodiment is not limited to a specific configuration of the communication channel, and examples of the communication channel may include a wireless local area network (LAN), a wired LAN, a wide area network (WAN), a public network, a mobile data communication network, and a combination thereof. However, the method of obtaining the distance information indicating the distance between the first wireless communication apparatus 3 and the second wireless communication apparatus 4 is not limited to these examples, and the obtaining section 11 may obtain the position information by any other technique. As an example, the obtaining section 11 may receive the position information of the first wireless communication apparatus 3 and the position information of the second wireless communication apparatus 4 from any other device other than the first wireless communication apparatus or 3 the second wireless communication apparatus 4. Further, as another technique, for example, in a case where the position of one of the wireless communication apparatuses is fixed, the fixed position information may be previously set in a setting file of the wireless communication apparatus and the obtaining section 11 may obtain the fixed position information from the setting file of the wireless communication apparatus.

The quality information is information associated with the quality of wireless communication performed between the first wireless communication apparatus 3 and the second wireless communication apparatus 4. As an example, the quality information may include at least one selected from the group consisting of a received signal strength, an amount of attenuation, a rate of packet loss, and an amount of delay of a signal transmitted from one of the first wireless communication apparatus 3 and the second wireless communication apparatus 4 and received by the other. However, the quality information is not limited to these examples, and may include any other information associated with the quality of wireless communication.

As an example, the obtaining section 11 may receive the quality information from one or both of the first wireless communication apparatus 3 and the second wireless communication apparatus 4 through a communication channel. However, the technique by which the obtaining section 11 obtains the quality information is not limited to this example, and the obtaining section 11 may obtain the quality information by any other technique. As an example, the obtaining section 11 may receive the quality information from any other apparatus other than the first wireless communication apparatus 3 the or second wireless communication apparatus 4.

### Decision Section 12

The decision section 12 decides an algorithm for determining the environment of a radio channel with reference to the distance information. Here, the environment of the radio channel is a condition around the radio channel, and may include, for example, weather or radio wave environment around the radio channel. Weather may include, for example, whether or not it is raining, or the precipitation when it is raining (how much rain falls). For example, the radio wave environment may include the strength of a radio wave, or the presence or absence of and the strength of an interfering radio wave that interferes with wireless communication. Hereunder, the environment of the radio channel may also be simply referred to as “environment”.

For example, the algorithm for determining the environment may include an algorithm that determines the environment by using a threshold, an algorithm that determines the environment by using a mathematical expression, or an algorithm that determines the environment by using a trained model.

In the case of the algorithm using a threshold, the decision section 12 decides a threshold for determining the environment with reference to the distance information. For example, the decision section 12 may decide a threshold by selecting one from a plurality of thresholds, or may calculate a threshold by calculation using the distance information. For example, the threshold included in the algorithm may be a threshold of at least one selected from the group consisting of a received signal strength, an amount of attenuation, a rate of packet loss, and an amount of delay of a signal transmitted from one of the first wireless communication apparatus 3 and the second wireless communication apparatus 4 and received by the other. However, the threshold included in the algorithm is not limited to these examples, and may be any other threshold for use in comparison with the quality information.

In the case of the algorithm using the mathematical expression or the trained model, the decision section 12 decides a coefficient and/or a parameter of the mathematical expression or the trained model, with reference to the distance information. When the trained model is generated by machine learning, the technique for performing the machine learning of the trained model is not limited, and, for example, a decision tree-based, linear regression, or neural network technique may be used, or alternatively, two or more of these techniques may be used. Examples of the decision tree-based method may include Light Gradient Boosting Machine (LightGBM), random forest, and XGBoost. Examples of the linear regression may include Bayesian regression, support vector regression, Ridge regression, Lasso regression, and ElasticNet. Examples of the neural network include deep learning.

### Determination Section 13

The determination section 13 determines the environment of the radio channel by using the quality information and the algorithm decided by the decision section 12. For example, the determination section 13 may determine the environment by using the threshold decided by the decision section 12. As another example, the determination section 13 may determine the environment by calculation with the mathematical expression using the coefficient and/or parameter decided by the decision section 12. Further, for example, the determination section 13 may infer the environment by inputting the quality information into a trained model that includes the parameter decided by the decision section 12. In this case, the trained model may be, for example, a model that receives quality information as input and outputs a label indicating the environment. As used in this specification, the term “determination” may include the meanings of “inference”.

The obtaining section 11, the decision section 12, and the determination section 13 may be included in a single apparatus or may be implemented by cooperation of a plurality of apparatuses. For example, the obtaining section 11, the decision section 12, and the determination section 13 may be connected through a communication channel. As an example, a first apparatus including the obtaining section 11, a second apparatus including the decision section 12, and a third apparatus including the determination section 13 may be connected through a communication channel. As another example, a first apparatus including the obtaining section 11, and a second apparatus including both the decision section 12 and the determination section 13 may be connected through a communication channel. Some or all of the obtaining section 11, the decision section 12, and the determination section 13 may be included in any one of the first wireless communication apparatus 3 and the second wireless communication apparatus 4. For example, at least one of the first apparatus, the second apparatus, and the third apparatus may be the first wireless communication apparatus 3 or the second wireless communication apparatus 4.

As described in the foregoing, the information processing system 1 in accordance with the present example embodiment employs a configuration in which: distance information that indicates the distance between the first wireless communication apparatus 3 and the second wireless communication apparatus 4, and quality information that is information associated with quality of communication are obtained; an algorithm for determining the environment of the radio channel is decided with reference to the distance information; and the environment of the radio channel is determined by using the quality information and the algorithm decided by the decision section 12. Since the algorithm decided by the decision section 12 alters in accordance with the distance between the wireless communication apparatuses, the environment determined by the determination section 13 is indicated by a determination result that reflects not only the quality information but also the distance between the wireless communication apparatuses. Thus, the information processing system 1 in accordance with the present example embodiment achieves an example advantage of being capable of determining the environment of the radio channel even in a case where the distance between the wireless communication apparatuses varies.

### Configuration of Information Processing Apparatus

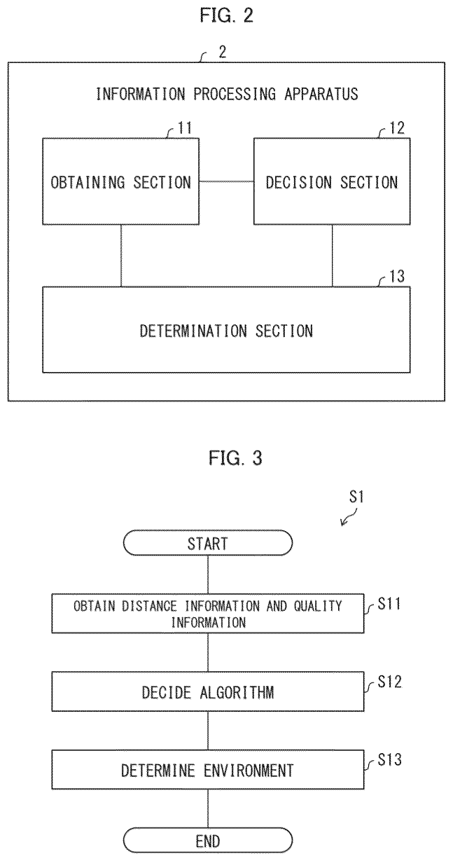

The configuration of an information processing apparatus 2 in accordance with the present example embodiment will be described with reference to FIG. 2. FIG. 2 is a block diagram illustrating the configuration of the information processing apparatus 2. The information processing apparatus 2 includes an obtaining section 11, a decision section 12, and a determination section 13. Here, the obtaining section 11, the decision section 12, and the determination section 13 are the same as the obtaining section 11, the decision section 12, and the determination section 13 included in the information processing system 1, respectively, and descriptions thereof will not be repeated here.

The information processing apparatus 2 in accordance with the present example embodiment employs a configuration in which: distance information that indicates the distance between the first wireless communication apparatus 3 and the second wireless communication apparatus 4, and quality information that is information associated with quality of communication are obtained; an algorithm for determining the environment of the radio channel is decided with reference to the distance information; and the environment of the radio channel is determined by using the quality information and the algorithm decided by the decision section 12. Since the algorithm decided by the decision section 12 alters in accordance with the distance between the wireless communication apparatuses, the environment determined by the determination section 13 is indicated by a determination result that reflects not only the quality information but also the distance between the wireless communication apparatuses. Thus, the information processing apparatus 2 in accordance with the present example embodiment achieves an example advantage of being capable of determining the environment of the radio channel even in a case where the distance between the wireless communication apparatuses varies.

### Flow of Information Processing Method

The flow of an information processing method S1 in accordance with the present example embodiment will be described with reference to FIG. 3. FIG. 3 is a flowchart illustrating the flow of the information processing method S1. In step S11, the obtaining section 11 obtains: distance information that indicates the distance between the first wireless communication apparatus 3 and the second wireless communication apparatus 4 that directly perform communication with each other through a radio channel; and quality information that is information associated with quality of the communication. In step S12, the decision section 12 decides an algorithm for determining the environment of the radio channel with reference to the distance information. In step S13, the determination section 13 determines the environment of the radio channel by using the quality information and the algorithm decided in step S12.

As described in the foregoing, the information processing method S1 in accordance with the present example embodiment employs a configuration in which: distance information that indicates the distance between the first wireless communication apparatus 3 and the second wireless communication apparatus 4, and quality information that is information associated with quality of communication are obtained; an algorithm for determining the environment of the radio channel is decided with reference to the distance information; and the environment of the radio channel is determined by using the quality information and the decided algorithm. Thus, the information processing method S1 in accordance with the present example embodiment achieves an example advantage of being capable of determining the environment of the radio channel even in a case where the distance between the wireless communication apparatuses varies.

### Second Example Embodiment

The following description will discuss a second example embodiment of the present invention in detail with reference to the drawings. It should be noted that any constituent element that is identical in function to a constituent element described in the first example embodiment will be given the same reference symbol, and a description thereof will not be repeated.

### Configuration of Information Processing System

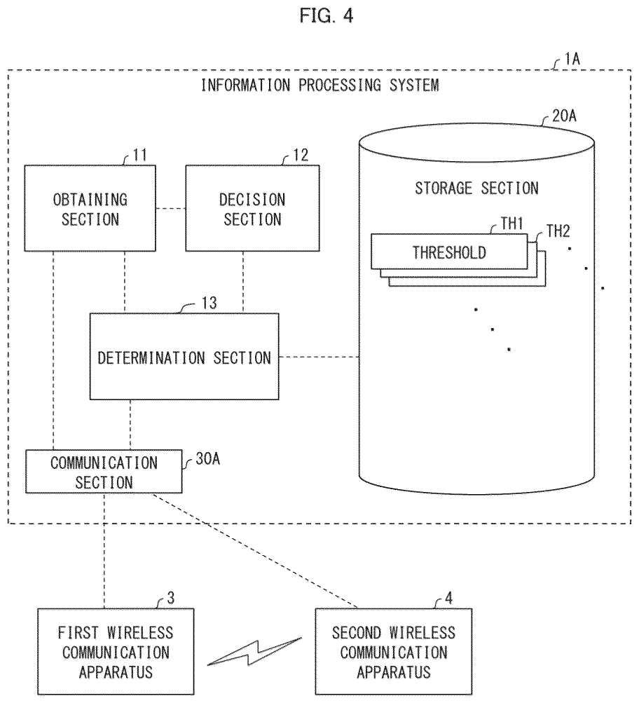

FIG. 4 is a block diagram illustrating the configuration of an information processing system 1A in accordance with the present example embodiment. The information processing system 1A determines the environment of a radio channel through which a first wireless communication apparatus 3 and a second wireless communication apparatus 4 communicate with each other. For example, the first wireless communication apparatus 3 and the second wireless communication apparatus 4 may be drones, UAVs, or automated guided vehicles. One or both of the first wireless communication apparatus 3 and the second wireless communication apparatus 4 may each include a moving mechanism that moves the wireless mobile apparatus to which the moving mechanism is provided. Further, in the present example embodiment, one or both of the first wireless communication apparatus 3 and the second wireless communication apparatus 4 each includes an image capturing apparatus (not illustrated) for capturing an image of the surroundings. It should be noted that this image capturing apparatus may be provided in a position that is neither the first wireless communication apparatus 3 nor the second wireless communication apparatus 4. For example, the image capturing apparatus may be a security camera disposed around the radio channel, or may be a camera included in another wireless communication apparatus.

The information processing system 1A includes obtaining section 11, a decision section 12, a determination section 13, a storage section 20A, and a communication section 30A.

### Communication Section 30A

The communication section 30A communicates with other apparatuses (the first wireless communication apparatus 3, the second wireless communication apparatus 4, and the like) through a communication channel. The present example embodiment is not limited to a specific configuration of the communication channel, and examples of the communication channel may include a wireless local area network (LAN), a wired LAN, a wide area network (WAN), a public network, a mobile data communication network, and a combination thereof. The communication section 30A transmits, to another apparatus, data supplied from, for example, the determination section 13, and supplies, to, for example, the obtaining section 11, data received from another apparatus.

### Obtaining Section 11

The obtaining section 11 obtains: distance information that indicates the distance between the first wireless communication apparatus 3 and the second wireless communication apparatus 4; and quality information that is information associated with quality of communication. In the present example embodiment, the obtaining section 11 receives position information from the first wireless communication apparatus 3 and the second wireless communication apparatus 4 via the communication section 30A, and calculates the distance between the first wireless communication apparatus 3 and the second wireless communication apparatus 4 by using the received position information. As an example, the position information may be position information determined by the GNSS. Further, the obtaining section 11 receives the quality information from one or both of the first wireless communication apparatus 3 and the second wireless communication apparatus 4 via the communication section 30A.

Further, the obtaining section 11 obtains a captured image, the position information, and external information. Here, the captured image is an image captured by the abovementioned image capturing apparatus. For example, the captured image may be an image in which a view of the surroundings of the wireless communication apparatus is captured, an image in which a view of the surroundings of the radio channel is captured, or an image obtained by one wireless communication apparatus capturing the other wireless communication apparatus. The external information is information obtained from the outside of the information processing system 1A by the obtaining section 11. For example, the external information may include weather observation information, weather forecast information, prediction of solar flare arrival, or test information of known nearby radio facilities, announced by the Meteorological Agency and the like.

### Decision Section 12

The decision section 12 decides an algorithm for determining the environment of the radio channel with reference to at least one selected from the group consisting of the distance information, the captured image, the position information, and the external information. In the present example embodiment, the decision section 12 decides a threshold that is included in the algorithm and is for use in comparison with the quality information, with reference to at least one selected from the group consisting of the distance information, the captured image, the position information, and the external information. As an example, the threshold included in the algorithm may include a threshold of a received signal strength, an amount of attenuation, a rate of packet loss, and an amount of delay of a signal transmitted from one of the first wireless communication apparatus 3 and the second wireless communication apparatus 4 and received by the other. The decision process of the threshold carried out by the decision section 12 will be described later.

### Determination Section 13

The determination section 13 determines the environment of the radio channel by using the quality information and the algorithm decided by the decision section 12. In the present example embodiment, the determination section 13 determines the environment of the radio channel by using the threshold decided by the decision section 12.

### Storage Section 20A

The storage section 20A stores the distance information and the quality information obtained by the obtaining section 11, and stores the environment information indicating the environment of the radio channel determined by the determination section 13. The storage section 20A stores a plurality of thresholds TH1, TH2, . . . . The plurality of thresholds TH1, TH2, . . . are thresholds for use by the determination section 13 to determine the environment of the radio channel.

### Flow of Information Processing Method

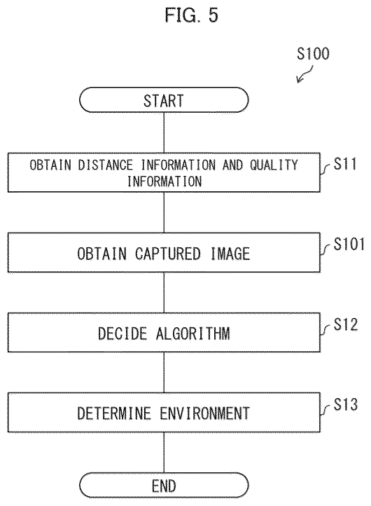

The flow of an information processing method in accordance with the present example embodiment will be described with reference to FIGS. 5 to 7. Hereunder, an information processing S100, method an information processing method S200, and an information processing method S300 will be described as specific examples of the information processing method carried out by the information processing system 1A.

### Information Processing Method S100

FIG. 5 is a flowchart illustrating the flow of the information processing method S100 carried out by the information processing system 1A. Here, some of the steps may be carried out in parallel or in a different order. Further, descriptions of the contents that have already been described will not be repeated.

### Step S11

In step S11, the obtaining section 11 obtains distance information and quality information. In the present example embodiment, the obtaining section 11 receives position information from the first wireless communication apparatus 3 and the second wireless communication apparatus 4 via the communication section 30A, and calculates the distance between the first wireless communication apparatus 3 and the second wireless communication apparatus 4 by using the received position information. Further, the obtaining section 11 receives the quality information from one or both of the first wireless communication apparatus 3 and the second wireless communication apparatus 4 via the communication section 30A.

The quality information obtained by the obtaining section 11 in the present example embodiment includes the received signal strength of a signal transmitted from one of the first wireless communication apparatus 3 and the second wireless communication apparatus 4 and received by the other. The quality information obtained by the obtaining section 11 also includes at least one selected from the group consisting of the amount of attenuation, the rate of packet loss, and the amount of delay of a signal transmitted from one of the first wireless communication apparatus 3 and the second wireless communication apparatus 4 and received by the other.

### Step S101

In step S101, the obtaining section 11 obtains a captured image obtained by the image capturing apparatus. Here, as described above, the captured image is an image captured by the abovementioned image capturing apparatus. For example, the captured image may be an image in which a view of the surroundings of the wireless communication apparatus is captured, an image in which a view of the surroundings of the radio channel is captured, or an image obtained by one wireless communication apparatus capturing the other wireless communication apparatus.

### Step S12

In step S12, the decision section 12 decides a threshold that is included in an algorithm for determining the environment and is for use in comparison with the quality information, with reference to one or both of the distance information and the captured image. Hereunder, first to fifth example processes will be described as specific examples of the process in which the decision section 12 decides a threshold. Here, the first and second example processes are each an example in which the decision section 12 decides a threshold with reference to the distance information. In contrast, the third example process is an example in which the decision section 12 decides a threshold with reference to the captured image. In addition, the fourth and fifth example processes are each an example in which the decision section 12 decides a threshold with reference to both the distance information and the captured image.

### First Example Process Carried Out in Step S12

In this example, the decision section 12 decides a threshold that is included in the algorithm and is for use in comparison with the received signal strength such that the threshold negatively correlates with the distance indicated by the distance information. In other words, as an example, the decision section 12 may lower the threshold of the received signal strength as the distance indicated by the distance information increases. Generally, as the distance between wireless communication apparatuses increases, the received signal strength of a signal transmitted and received between the wireless communication apparatuses decreases. Thus, by lowering the threshold of the received signal strength as the distance increases, it is possible to reduce the effect of distance in determining the environment of the radio channel.

### Second Example Process Carried Out in Step S12

Further, in step S12, the decision section 12 may decide a threshold that is included in the algorithm and is for use in comparison with at least one selected from the group consisting of the amount of attenuation, the rate of packet loss, and the amount of delay, such that the threshold positively correlates with the distance indicated by the distance information. In other words, as an example, the decision section 12 may increase a threshold of the amount of attenuation, a threshold of the rate of packet loss, and a threshold of an amount of delay, as the distance indicated by the distance information increases. Generally, the greater distance between wireless communication apparatuses, the greater the amount of attenuation, the rate of packet loss, and the amount of delay. Thus, by increasing these thresholds as the distance increases, it is possible to reduce the effect of distance in determining the environment of the radio channel.

### Third Example Process Carried Out in Step S12

In this example, the decision section 12 decides the ambient condition of the wireless communication apparatus with reference to the captured image. For example, the ambient condition may indicate whether the wireless communication apparatus is in an urban area, in a suburban area, or on the sea, or whether there is any nearby facility that can be a candidate of an interference source (such as an antenna of another radio apparatus). As an example, the decision section 12 may determine the ambient condition by image analysis of the captured image. Further, the decision section 12 may infer the ambient condition by inputting the captured image into a trained model that is constructed by machine learning and is configured to receive a captured image as input and output a label indicating the ambient condition captured by the captured image.

The decision section 12 switches thresholds of the algorithm in accordance with the result of the type determination. As an example, when a nearby facility serving as an interference source candidate is present, the decision section 12 may lower the threshold of the received signal strength as compared with a case where no nearby facility, serving as the interference source candidate, is present. As another example, when the determination result indicates an urban area, the decision section 12 may lower the threshold of the received signal strength as compared with the case of a suburban area.

### Fourth Example Process Carried Out in Step S12

In this example, the decision section 12 decides the algorithm with further reference to the captured image, in addition to the distance information. As an example, the decision section 12 may decides an algorithm for determining the environment of the radio channel, by selectively referring to one or both of the distance information and the captured image. In this case, for example, when the ambient condition of the wireless communication apparatus satisfies a predetermined condition, the decision section 12 may carry out (i) a first process in which the algorithm is decided with reference to the captured image, whereas when the ambient condition does not satisfy the condition, the decision section 12 may carry out (ii) a second process in which the algorithm is decided with reference to the distance information. Here, the predetermined condition may be, for example, a condition that the brightness of the captured image is not less than the predetermined brightness or the time is within a predetermined time slot. In other words, the decision section 12 switches between the first process and the second process in accordance with the predetermined condition. As an example, the decision section 12 may carry out the first process when the brightness of the captured image is not less than the predetermined brightness, and may otherwise carry out the second process.

Here, (i) the first process in which the algorithm is decided with reference to the captured image may be, as an example, the process described above in the third example process. That is, in the first process, the decision section 12 carries out image analysis of the captured image to determine the ambient condition of the wireless communication apparatus, and decides a threshold of the algorithm in accordance with the determination result. In contrast, (ii) the second process in which the algorithm is decided with reference to the distance information may be, as an example, the process described above in the first or second example process. That is, in the second process, the decision section 12 decides a threshold of the algorithm with reference to the distance information.

Further, as an example, the predetermined condition may be a condition that the environment of the radio channel can be determined from the captured image. In this case, in other words, the decision section 12 decides the algorithm with reference to at least the distance information when the environment of the radio channel cannot be determined from the captured image. Here, the case where the environment of the radio channel cannot be determined from the captured image may include, for example, a case where the brightness of the captured image is not more than a predetermined brightness; or a case where the captured image shows water droplets or water pools. In such a case where the environment of the radio channel cannot be determined from the captured image, the decision section 12 decides the algorithm with reference to at least the distance information. On the other hand, in a case where the environment of the radio channel can be determined from the captured image, the decision section 12 may, for example, analyze the captured image and determine that the weather is rainy when water droplets or water pools are shown in the captured image, or determines that the weather is cloudy when the brightness of the captured image is not more than a predetermined value.

### Fifth Example Process Carried Out in Step S12

Further, in step S12, when the brightness of the captured image is not less than the predetermined brightness, the decision section 12 may select, as the algorithm, an algorithm that uses the quality information, the distance information, and the captured image, whereas when the brightness of the captured image is less than the predetermined brightness, the decision section 12 may select, as the algorithm, an algorithm that uses the quality information and the distance information, but does not use the captured image.

### Step S13

In step S13, the determination section 13 determines the environment of the radio channel by using the threshold decided by the decision section 12. In the present example embodiment, the determination section 13 may infer an environmental factor that makes a difference between a value indicated by the quality information and the threshold decided by the decision section 12, as the environment of the radio channel. As an example, when the received signal strength is less than the threshold, the determination section 13 determines that the weather is rainy, whereas when the received signal strength is not less than the threshold, the determination section 13 may determine that the weather is fine.

The determination section 13 outputs the environment information indicating the determined environment. As an example, the determination section 13 may output the environment information by writing the environment information in the storage section 20A or an external storage, or alternatively, may output the environment information by transmitting the environment information to another apparatus via the communication section 30A. The determination section 13 may output the environment information to a predetermined output apparatus (not illustrated). The output apparatus may include, for example, a display, a printer, a projector, or a speaker.

### Information Processing Method S200

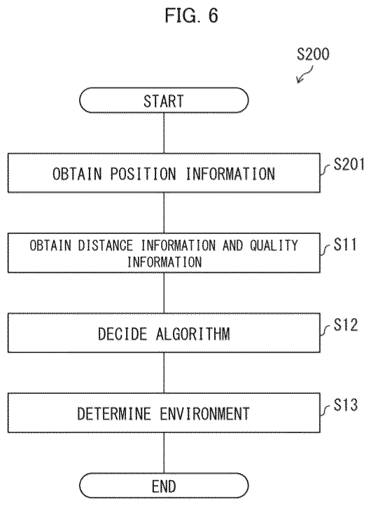

FIG. 6 is a flowchart illustrating the flow of the information processing method S200 carried out by the information processing system 1A. The information processing method S200 includes steps S201, and S11 to S13. Of these steps, steps S11 and S13 are the same as steps S11 and S13 included in the information processing method S100 described above, and descriptions thereof will not be repeated here. Here, some of the steps may be carried out in parallel or in a different order. Further, descriptions of the contents that have already been described will not be repeated.

### Step S201

In step S201, the obtaining section 11 obtains position information of one or both of the first wireless communication apparatus 3 and the second wireless communication apparatus 4. As an example, the obtaining section 11 may receive position information of the first wireless communication apparatus 3 from the first wireless communication apparatus 3 and position information of the second wireless communication apparatus 4 from the second wireless communication apparatus 4.

### Step S12

In step S12, the decision section 12 decides a threshold included in the algorithm with reference to one or both of the distance information and the position information. Hereunder, sixth and seventh example processes will be described as specific examples of the process in which the decision section 12 decides a threshold. The sixth example process is an example in which the decision section 12 decides a threshold with reference to the position information, and the seventh example process is an example in which the decision section 12 decides a threshold with reference to the distance information and the position information.

### Sixth Example Process Carried Out in Step S12

In this example, the decision section 12 decides a threshold with reference to the position information. As an example, the decision section 12 may decide a threshold corresponding to the obtained position information by using a parameter or a mathematical expression or the like for use in threshold calculation predetermined for each latitude/longitude. As an example, the decision section 12 may select any one of a plurality of algorithms with reference to the position information.

### Seventh Example Process Carried Out in Step S12

In step S12, the decision section 12 may decide an algorithm with further reference to the position information obtained in step S201. As an example, the decision section 12 may decide an algorithm for determining the environment of the radio channel, by selectively referring to one or both of the distance information and the position information. In this case, for example, when the ambient condition of the wireless communication apparatus satisfies a predetermined condition, the decision section 12 may carry out (iii) a third process in which the algorithm is decided with reference to the position information, whereas when the ambient condition does not satisfy the condition, the decision section 12 may carry out (ii) the second process in which the algorithm is decided with reference to the distance information. Here, as an example, the predetermined condition may be a condition that the position indicated by the position information is within a predetermined area. In other words, the decision section 12 switches between the third process and the second process in accordance with the predetermined condition. As an example, the decision section 12 may carry out the third process when the position indicated by the position information is within the predetermined area, and may otherwise carry out a fourth process.

Here, (iii) the third process in which the algorithm is decided with reference to the position information may be, as an example, the process described above in the sixth example process. That is, in the third process, the decision section 12 decides a threshold of the algorithm with reference to the position information. In contrast, (ii) the second process in which the algorithm is decided with reference to the distance information may be, as an example, the process described above in the first or second example process. That is, in the second process, the decision section 12 decides a threshold of the algorithm with reference to the distance information.

### Information Processing Method S300

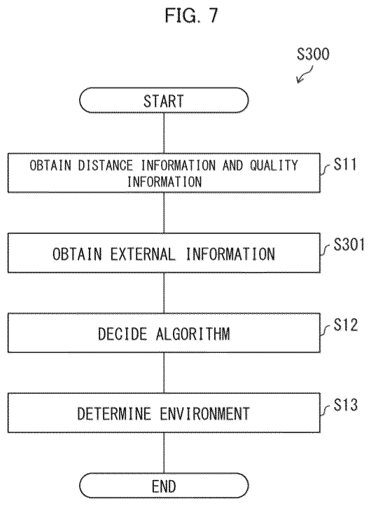

FIG. 7 is a flowchart illustrating the flow of the information processing method S300 carried out by the information processing system 1A. The information processing method S300 includes steps S11, S301, S12, and S13. Of these steps, steps S11 and S13 are the same as steps S11 and S13 included in the information processing method S100 described above, and descriptions thereof will not be repeated here. Here, some of the steps may be carried out in parallel or in a different order. Further, descriptions of the contents that have already been described will not be repeated.

### Step S301

In step S301, the obtaining section 11 obtains external information. As an example, the obtaining section 11 may obtain the external information by receiving the external information from a predetermined external server, or may obtain the external information by reading the external information from the storage section 20A or another storage.

### Step S12

In step S12, the decision section 12 decides a threshold included in the algorithm with reference to one or both of the distance information and the external information. Hereunder, eighth and ninth example processes will be described as specific examples of the process in which the decision section 12 decides a threshold. The eighth example process is an example in which the decision section 12 decides a threshold with reference to the external information, and the ninth example process is an example in which the decision section 12 decides a threshold with reference to the distance information and the external information.

### Eighth Example Process Carried Out in Step S12

In this example, the decision section 12 decides a threshold with reference to the external information. As an example, the decision section 12 may decide a threshold corresponding to the obtained external information by using a parameter or a mathematical expression or the like for use in threshold calculation predetermined for each piece of the external information. As an example, the decision section 12 may lower a threshold of the received signal strength of a signal when some test is carried out in a nearby radio facility. As an example, the decision section 12 may select any one of a plurality of algorithms with reference to the external information.

### Ninth Example Process Carried Out in Step S12

In step S12, the decision section 12 may decide an algorithm with further reference to the external information. As an example, the decision section 12 may decide an algorithm for determining the environment of the radio channel, by selectively referring to one or both of the distance information and the external information. In this case, for example, when the ambient condition of the wireless communication apparatus satisfies a predetermined condition, the decision section 12 may carry out (iv) a fourth process in which the algorithm is decided with reference to the external information, whereas when the ambient condition does not satisfy the condition, the decision section 12 may carry out (ii) the second process in which the algorithm is decided with reference to the distance information. Here, as an example, the predetermined condition may be a condition that the position indicated by the position information is within a predetermined area. In other words, the decision section 12 switches between the fourth process and the second process in accordance with the predetermined condition.

Here, (iv) the fourth process in which the algorithm is decided with reference to the external information may be, as an example, the process described above in the eighth example process. That is, in the fourth process, the decision section 12 decides a threshold of the algorithm with reference to the external information. In contrast, (ii) the second process in which the algorithm is decided with reference to the distance information may be, as an example, the process described above in the first or second example process. That is, in the second process, the decision section 12 decides a threshold of the algorithm with reference to the distance information.

### Example Advantages of Information Processing System

As described in the foregoing, the information processing system 1A in accordance with the present example embodiment employs a configuration in which a threshold that is included in the algorithm and is for use in comparison with the quality information is decided with reference to the distance information. Therefore, according to the information processing system 1A in accordance with the present example embodiment, it is possible to achieve an example advantage of being capable of suitably determining the environment of the radio channel compared to not deciding the threshold with reference to the distance information, in addition to the example advantage achieved by the information processing system 1 in accordance with the first example embodiment.

Further, the information processing system 1A in accordance with the present example embodiment employs a configuration in which the quality information includes the received signal strength of a signal transmitted from one of the first wireless communication apparatus 3 and the second wireless communication apparatus 4 and received by the other, and the threshold that is included in the algorithm and is for use in comparison with the received signal strength is decided such that the threshold negatively correlates with the distance indicated by the distance information. Thus, according to the information processing system 1A in accordance with the present example embodiment, it is possible to achieve an example advantage of being capable of suitably determining the environment of the radio channel compared to not lowering the threshold of the received signal strength of the signal as the distance indicated by the distance information increases, in addition to the example advantage achieved by the information processing system 1 in accordance with the first example embodiment.

### Third Example Embodiment

A third example embodiment of the present invention will be described in detail with reference to the drawings. Here, any constituent element that is identical in function to a constituent element described in the first or second example embodiment will be given the same reference symbol, and a description thereof will not be repeated.

### Configuration of Information Processing System

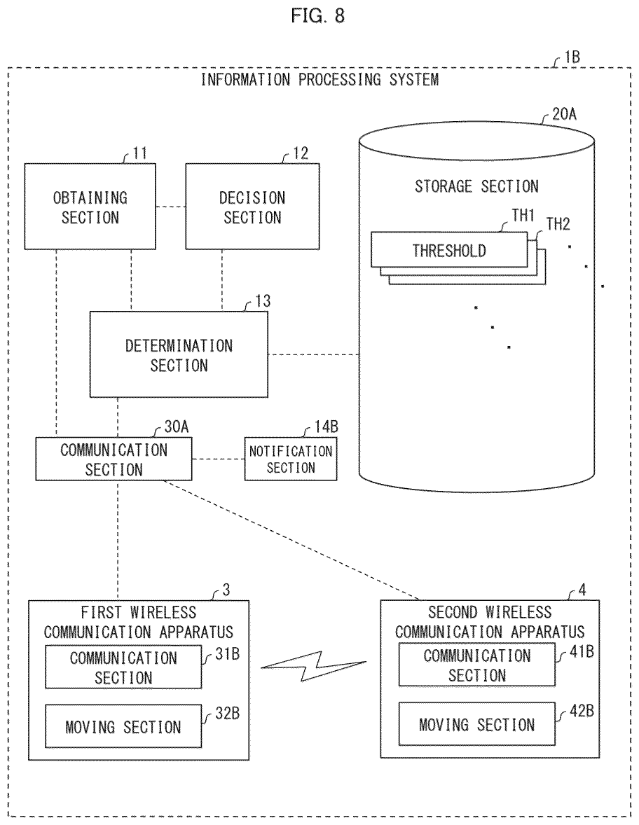

FIG. 8 is a block diagram illustrating the configuration of an information processing system 1B in accordance with the present example embodiment. The information processing system 1A includes an obtaining section 11, a decision section 12, a determination section 13, a storage section 20A, and a communication section 30A. The information processing system 1B also includes a first wireless communication apparatus 3, a second wireless communication apparatus 4, and a notification section 14B.

The notification section 14B notifies the first wireless communication apparatus 3 and the second wireless communication apparatus 4 of a monitoring target. The monitoring target is a target for determination of the environment performed by the information processing system 1B, and may include, for example, a travel path or a travel area of the wireless communication apparatus. As an example, a monitored path may be notified by the notification section 14B as the monitoring target. Alternatively, a monitored area may be notified by the notification section 14B as the monitoring target.

In the information processing system 1B, the first wireless communication apparatus 3 includes a communication section 31B and a moving section 32B. The communication section 31B communicates with the communication section 30A and the second wireless communication apparatus 4. The moving section 32B is a moving mechanism that moves the first wireless communication apparatus 3, and may be, for example, a propeller, a wheel, or a crawler. The second wireless communication apparatus 4 includes a communication section 41B and a moving section 42B. The communication section 41B communicates with the communication section 30A and the first wireless communication apparatus 3. The moving section 42B is a moving mechanism that moves the second wireless communication apparatus 4, and may be, for example, a propeller, a wheel, or a crawler.

The first wireless communication apparatus 3 and the second wireless communication apparatus 4 move so that the radio channel includes at least part of the monitoring target notified by the notification section 14B. In other words, each of the first wireless communication apparatus 3 and the second wireless communication apparatus 4 includes moving means for moving the wireless communication apparatus to which the moving means is provided (i.e., moving section 32B, moving section 42B) so that the radio channel includes at least part of the monitoring target notified by the notification section 14B. Here, when the monitored path is notified as the monitoring target by the notification section 14B, the moving section 32B and the moving section 42B move the respective wireless communication apparatuses to positions on the monitored path notified by the notification section 14B. In addition, when the management area is notified as the monitoring target by the notification section 14B, the moving section 32B and the moving section 42B move the respective wireless communication apparatuses to positions on the outer periphery of the monitored area.

### Specific Example of Monitored Path

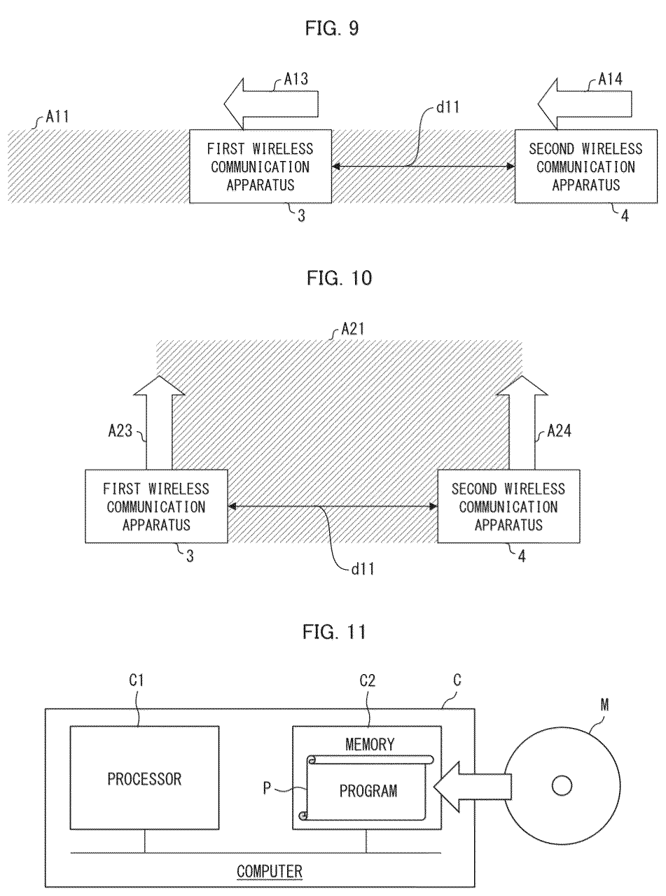

FIG. 9 is a diagram illustrating a specific example of the monitored path. In FIG. 9, the first wireless communication apparatus 3 moves along a monitored path A11 in a direction indicated by arrow A13 and the second wireless communication apparatus 4 moves along the monitored path A11 in a direction indicated by arrow A14. The decision section 12 decides the algorithm with reference to the distance d11 between the first wireless communication apparatus 3 and the second wireless communication apparatus 4, and determines the environment of the radio channel by using the quality information and the decided algorithm.

As an example, the notification section 14B may notify the first wireless communication apparatus 3 and the second wireless communication apparatus 4 of the monitored path. In this case, the first wireless communication apparatus 3 and the second wireless communication apparatus 4 move to positions on the notified monitored path. Further, the notification section 14B may notify one of the first wireless communication apparatus 3 and the second wireless communication apparatus 4 of the monitored path. In this case, as an example, one wireless communication apparatus to which the monitored path has been notified may notify the other wireless communication apparatus of the monitored path or the position on the monitored path.

Further, the notification section 14B may notify the first wireless communication apparatus 3 and the second wireless communication apparatus 4 of positions on the monitored path. In this case, the first wireless communication apparatus 3 and the second wireless communication apparatus 4 move to the notified positions. Further, the notification section 14B may notify one of the first wireless communication apparatus 3 and the second wireless communication apparatus 4 of positions. In this case, as an example, one wireless communication apparatus to which the positions have been notified may notify the other wireless communication apparatus of a position of the destination.

### Specific Example of Monitored Area

FIG. 10 is a diagram illustrating a specific example of the monitored area. In the example of FIG. 10, the first wireless communication apparatus 3 moves on the outer periphery of a monitored area A21 in a direction indicated by arrow A23, and the second wireless communication apparatus 4 moves on the outer periphery of the monitored area A21 in a direction indicated by arrow A24. The decision section 12 decides the algorithm with reference to the distance d21 between the first wireless communication apparatus 3 and the second wireless communication apparatus 4, and determines the environment of the radio channel by using the quality information and the decided algorithm.

As an example, the notification section 14B may notify the first wireless communication apparatus 3 and the second wireless communication apparatus 4 of the monitored area. In this case, the first wireless communication apparatus 3 and the second wireless communication apparatus 4 move to positions on the outer periphery of the notified monitored area. Further, the notification section 14B may notify one of the first wireless communication apparatus 3 and the second wireless communication apparatus 4 of the monitored area. In this case, as an example, one wireless communication apparatus to which the monitored area has been notified may notify the other wireless communication apparatus of the monitored area or the position on the outer periphery of the monitored area.

Further, as an example, the notification section 14B may notify the first wireless communication apparatus 3 and the second wireless communication apparatus 4 of positions on the outer periphery of the monitored area. In this case, the first wireless communication apparatus 3 and the second wireless communication apparatus 4 move to the notified positions. Further, the notification section 14B may notify one of the first wireless communication apparatus 3 and the second wireless communication apparatus 4 of positions on the outer periphery of the monitored area. In this case, as an example, one wireless communication apparatus to which the positions have been notified may notify the other wireless communication apparatus of the positions.

Although the foregoing examples of FIGS. 9 and 10 describe the cases where both the first wireless communication apparatus 3 and the second wireless communication apparatus 4 move, one of the first wireless communication apparatus 3 and the second wireless communication apparatus 4 may move. For example, the determination of the environment of the monitoring target may be performed with the information processing system 1B by having the second wireless communication apparatus 4 move while the first wireless communication apparatus 3 is stopped, and the determination of the environment of the monitoring target may be performed with the information processing system 1B by having the first wireless communication apparatus 3 move while the second wireless communication apparatus 4 is stopped. As an example, while the first wireless communication apparatus 3 stays in one position within the monitored area (e.g., hovering), the second wireless communication apparatus 4 may circle around the first wireless communication apparatus 3, to allow the information processing system 1B to determine the environment of the monitored area.

### Example Advantages of Information Processing System

As described in the foregoing, the information processing system 1B in accordance with the present example embodiment employs a configuration in which the first wireless communication apparatus 3 and the second wireless communication apparatus 4 are notified of the monitoring target, and each of the first wireless communication apparatus 3 and the second wireless communication apparatus 4 includes the monitoring means for moving the wireless communication apparatus to which the moving means is provided so that the radio channel includes at least part of the notified monitoring target. Thus, according to the information processing system 1B in accordance with the present example embodiment, it is possible to achieve an example advantage of being capable of determining the environment of the monitoring target in various positions, in addition to the example advantage achieved by the information processing system 1 in accordance with the first example embodiment.

### Software Implementation Example

Some or all of the functions of each of the information processing systems 1, 1A, and 1B may be implemented by hardware such as an integrated circuit (IC chip), or may be alternatively implemented by software.

In the latter case, the information processing systems 1, 1A, and 1B are implemented by, for example, a computer that executes instructions of a program that is software implementing the foregoing functions. FIG. 11 illustrates an example of such a computer (hereinafter, referred to as “computer C”). The computer C includes at least one processor C1 and at least one memory C2. The memory C2 stores a program P for causing the computer C to operate as each of the information processing systems 1, 1A, and 1B. The processor C1 of the computer C retrieves the program P from the memory C2 and executes the program P, so that the functions of the information processing systems 1, 1A, and 1B are implemented.

Examples of the processor C1 can include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. The memory C2 can be, for example, a flash memory, a hard disk drive (HDD), a solid state drive (SSD), or a combination of these.

Note that the computer C may further include a random access memory (RAM) in which the program P is loaded when the program P is executed and/or in which various kinds of data are temporarily stored. The computer C may further include a communication interface for transmitting and receiving data to and from other apparatuses. The computer C may further include an input/output interface for connecting input/output apparatuses such as a keyboard, a mouse, a display, and a printer.

The program P can be stored in a non-transitory tangible storage medium M that is readable by the computer C. Such a storage medium M may be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can acquire the program P via the transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the above example embodiments can be described as below. However, the present invention is not limited to example aspects described below.

### Supplementary Note 1

An information processing system including:
obtaining means for obtaining distance information that indicates a distance between a first wireless communication apparatus and a second wireless communication apparatus that directly perform communication with each other through a radio channel, and quality information that is information associated with quality of the communication;
decision means for deciding an algorithm for determining an environment of the radio channel with reference to the distance information; and
determination means for determining the environment of the radio channel by using the quality information and the algorithm decided by the decision means.

With this configuration, it is possible to determine the environment of the radio channel even in a case where the distance between the wireless communication apparatuses varies.

### Supplementary Note 2

The information processing system according to Supplementary note 1, wherein the decision means decides, with reference to the distance information, a threshold that is included in the algorithm and is for use in comparison with the quality information.

With this configuration, it is possible to more suitably determine the environment of the radio channel compared to not determining the threshold for use in determination of the environment with reference to the distance information.

### Supplementary Note 3

The information processing system according to Supplementary note 2, wherein
the quality information includes a received signal strength of a signal transmitted from one of the first wireless communication apparatus and the second wireless communication apparatus and received by the other, and
the decision means decides a threshold that is included in the algorithm and is for use in comparison with the received signal strength such that the threshold negatively correlates with the distance indicated by the distance information.

With this configuration, it is possible to more suitably determine the environment of the radio channel compared to not lowering the threshold of the received signal strength of the signal as the distance indicated by the distance information increases.

### Supplementary Note 4

The information processing system according to Supplementary note 2 or 3, wherein
the quality information includes at least one selected from the group consisting of an amount of attenuation, a rate of packet loss, and an amount of delay of a signal transmitted from one of the first wireless communication apparatus and the second wireless communication apparatus and received by the other, and
the decision means decides a threshold that is included in the algorithm and is for use in comparison with the at least one selected from the group consisting of the amount of attenuation, the rate of packet loss, and the amount of delay, such that the threshold positively correlates with the distance indicated by the distance information.

With this configuration, it is possible to more suitably determine the environment of the radio channel compared to not increasing the threshold of at least one selected from the group consisting of the amount of attenuation, the rate of packet loss, and the amount of delay of the signal as the distance indicated by the distance information increases.

### Supplementary Note 5

The information processing system according to any one of Supplementary notes 2 to 4, wherein the determination means infers an environmental factor that makes a difference between a value indicated by the quality information and the threshold, as the environment of the radio channel.

With this configuration, it is possible to infer the environmental factor affecting the quality of the radio channel.

### Supplementary Note 6

The information processing system according to any one of Supplementary notes 1 to 5, wherein
the obtaining means further obtains a captured image obtained by an image capturing apparatus; and
the decision means decides the algorithm with further reference to the captured image.

With this configuration, it is possible to more suitably determine the environment of the radio channel compared to not deciding the algorithm with reference to the captured image.

### Supplementary Note 7

The information processing system according to Supplementary note 6, wherein the decision means decides the algorithm with reference to at least the distance information when the decision means is unable to determine the environment of the radio channel based on the captured image.

With this configuration, it is possible to more suitably determine the environment of the radio channel compared to not selecting the algorithm in accordance with the brightness of the captured image.

### Supplementary Note 8

The information processing system according to any one of Supplementary notes 1 to 7, wherein
the obtaining means further obtains position information of one or both of the first wireless communication apparatus and the second wireless communication apparatus, and
the decision means decides the algorithm with further reference to the position information.

With this configuration, it is possible to more suitably determine the environment of the radio channel compared to not deciding the algorithm with reference to the position information.

### Supplementary Note 9

The information processing system according to any one of Supplementary notes 1 to 8, wherein
the obtaining means further obtains external information, and
the decision means decides the algorithm with further reference to the external information.

With this configuration, it is possible to more suitably determine the environment of the radio channel compared to not deciding the algorithm with reference to the external information.

### Supplementary Note 10

The information processing system according to any one of Supplementary notes 1 to 9, further including:
the first wireless communication apparatus and the second wireless communication apparatus; and
notification means for notifying the first wireless communication apparatus and the second wireless communication apparatus of a monitoring target,
wherein each of the first wireless communication apparatus and the second wireless communication apparatus includes moving means for moving the wireless communication apparatus to which the moving means is provided, such that the radio channel includes at least part of the monitoring target notified by the notification means.

With this configuration, it is possible to determine the environment of the monitoring target at various positions.

### Supplementary Note 11

The information processing system according to Supplementary note 10, wherein
the notification means notifies a monitored path as the monitoring target, and
the moving means moves the wireless communication apparatus to a position on the monitored path.

With this configuration, it is possible to determine the environment of the monitored path.

### Supplementary Note 12

The information processing system according to Supplementary note 11, wherein
the notification means notifies a monitored area as the monitoring target, and
the moving means moves the wireless communication apparatus to a position on an outer periphery of the monitored area.

With this configuration, it is possible to determine the environment of the monitored area.

(Supplementary Note 13)

An information processing apparatus including:
obtaining means for obtaining distance information that indicates a distance between a first wireless communication apparatus and a second wireless communication apparatus that directly perform communication with each other through a radio channel, and quality information that is information associated with quality of the communication;
decision means for deciding an algorithm for determining an environment of the radio channel with reference to the distance information; and
determination means for determining the environment of the radio channel by using the quality information and the algorithm decided by the decision means.

With this configuration, it is possible to determine the environment of the radio channel even in a case where the distance between the wireless communication apparatuses varies.

### Supplementary Note 14

An information processing method including:
obtaining distance information that indicates a distance between a first wireless communication apparatus and a second wireless communication apparatus that directly perform communication with each other through a radio channel, and quality information that is information associated with quality of the communication;
deciding an algorithm for determining an environment of the radio channel with reference to the distance information; and
determining the environment of the radio channel by using the quality information and the decided algorithm.

With this information processing method, it is possible to determine the environment of the radio channel even in a case where the distance between wireless communication apparatuses varies.

### Supplementary Note 15

A program for causing a computer to carry out:
an obtaining process of obtaining distance information that indicates a distance between a first wireless communication apparatus and a second wireless communication apparatus that directly perform communication with each other through a radio channel, and quality information that is information associated with quality of the communication;
a decision process of deciding an algorithm for determining an environment of the radio channel with reference to the distance information; and
a determination process of determining the environment of the radio channel by using the quality information and the algorithm decided in the decision process.

With this configuration, it is possible to determine the environment of the radio channel even in a case where the distance between the wireless communication apparatuses varies.

### Supplementary Note 16

An information processing system including:
obtaining means for obtaining distance information that indicates a distance between a first wireless communication apparatus and a second wireless communication apparatus that directly perform communication with each other through a radio channel, quality information that is information associated with quality of the communication, and a captured image obtained by an image capturing apparatus provided to one or both of the first wireless communication apparatus and the second wireless communication apparatus;
decision means for deciding an algorithm for determining an environment of the radio channel, by selectively referring to one or both of the distance information and the captured image; and
determination means for determining the environment of the radio channel by using the quality information and the algorithm decided by the decision means.

With this configuration, it is possible to determine the environment of the radio channel even in a case where the distance between the wireless communication apparatuses varies.

### Supplementary Note 17

An information processing system including:
obtaining means for obtaining distance information that indicates a distance between a first wireless communication apparatus and a second wireless communication apparatus that directly perform communication with each other through a radio channel, quality information that is information associated with quality of the communication, and position information of one or both of the first wireless communication apparatus and the second wireless communication apparatus;
decision means for deciding an algorithm for determining an environment of the radio channel, by selectively referring to one or both of the distance information and the position information; and
determination means for determining the environment of the radio channel by using the quality information and the algorithm decided by the decision means.

With this configuration, it is possible to determine the environment of the radio channel even in a case where the distance between the wireless communication apparatuses varies.

### Supplementary Note 18

An information processing system including:
obtaining means for obtaining distance information that indicates a distance between a first wireless communication apparatus and a second wireless communication apparatus that directly perform communication with each other through a radio channel, quality information that is information associated with quality of the communication, and external information;
decision means for deciding an algorithm for determining an environment of the radio channel, by selectively referring to one or both of the distance information and the external information; and
determination means for determining the environment of the radio channel by using the quality information and the algorithm decided by the decision means.

With this configuration, it is possible to determine the environment of the radio channel even in a case where the distance between the wireless communication apparatuses varies.

### Additional Remark 3

Some or all of the above example embodiments can also be described as below.

An information processing system including at least one processor, the at least one processor carrying out: an obtaining process of obtaining distance information that indicates a distance between a first wireless communication apparatus and a second wireless communication apparatus that directly perform communication with each other through a radio channel, and quality information that is information associated with quality of the communication; a decision process of deciding an algorithm for determining an environment of the radio channel with reference to the distance information; and a determination process of determining the environment of the radio channel by using the quality information and the algorithm decided in the decision process.

Note that the information processing system may further include a memory. The memory may store a program for causing the processor to carry out the obtaining process, the decision process, and the determination process. The program may be stored in a computer-readable non-transitory tangible storage medium.

### REFERENCE SIGNS LIST

1, 1A, 1B Information processing system
2 Information processing apparatus
3 First wireless communication apparatus
4 Second wireless communication apparatus
11 Obtaining section
12 Decision section
13 Determination section
14B Notification section
20A Storage section
30A, 31B, 41B Communication section
32B, 42B Moving section
S1, S100, S200, S300 Information processing method

What is claimed is:

1. An information processing system comprising at least one processor, the at least one processor carrying out:
an obtaining process of obtaining distance information that indicates a distance between a first wireless communication apparatus and a second wireless communication apparatus that directly perform communication with each other through a radio channel, and quality information that is information associated with quality of the communication;
a decision process of deciding an algorithm for determining an environment of the radio channel with reference to the distance information; and
a determination process of determining the environment of the radio channel by using the quality information and the algorithm decided in the decision means process.

2. The information processing system according to claim 1, wherein in the decision process, the at least one processor decides, with reference to the distance information, a threshold that is included in the algorithm and is for use in comparison with the quality information.

3. The information processing system according to claim 2, wherein
the quality information includes a received signal strength of a signal transmitted from one of the first wireless communication apparatus and the second wireless communication apparatus and received by the other, and
in the decision process, the at least one processor decides a threshold that is included in the algorithm and is for use in comparison with the received signal strength such that the threshold negatively correlates with the distance indicated by the distance information.

4. The information processing system according to claim 2, wherein
the quality information includes at least one selected from the group consisting of an amount of attenuation, a rate of packet loss, and an amount of delay of a signal transmitted from one of the first wireless communication apparatus and the second wireless communication apparatus and received by the other, and
in the decision process, the at least one processor decides a threshold that is included in the algorithm and is for use in comparison with the at least one selected from the group consisting of the amount of attenuation, the rate of packet loss, and the amount of delay, such that the threshold positively correlates with the distance indicated by the distance information.

5. The information processing system according to claim 2, wherein in the determination process, the at least one processor infers an environmental factor that makes a difference between a value indicated by the quality information and the threshold, as the environment of the radio channel.

6. The information processing system according to claim 1, wherein
in the obtaining process, the at least one processor further obtains a captured image obtained by an image capturing apparatus; and
in the decision process, the at least one processor decides the algorithm with further reference to the captured image.

7. The information processing system according to claim 6, wherein in the decision process, the at least one processor decides the algorithm with reference to at least the distance information when the decision means is unable to determine the environment of the radio channel based on the captured image.

8. The information processing system according to claim 1, wherein
in the obtaining process, the at least one processor further obtains position information of one or both of the first wireless communication apparatus and the second wireless communication apparatus, and
in the decision process, the at least one processor decides the algorithm with further reference to the position information.

9. The information processing system according to claim 1, wherein
in the obtaining process, the at least one processor further obtains external information, and
in the decision process, the at least one processor decides the algorithm with further reference to the external information.

10. The information processing system according to claim 1, further comprising
the first wireless communication apparatus and the second wireless communication apparatus,
the at least one processor further carrying out a notification process of notifying the first wireless communication apparatus and the second wireless communication apparatus of a monitoring target,
wherein each of the first wireless communication apparatus and the second wireless communication apparatus comprises a moving mechanism that moves the wireless communication apparatus to which the moving mechanism is provided, such that the radio channel includes at least part of the monitoring target notified in the notification process.

11. The information processing system according to claim 10, wherein
in the notification process, the at least one processor notifies a monitored path as the monitoring target, and
the moving mechanism moves the wireless communication apparatus to a position on the monitored path.

12. The information processing system according to claim 11, wherein
in the notification process, the at least one processor notifies a monitored area as the monitoring target, and
the moving mechanism moves the wireless communication apparatus to a position on an outer periphery of the monitored area.

13. An information processing apparatus comprising at least one processor, the at least one processor carrying out:
an obtaining process of obtaining distance information that indicates a distance between a first wireless communication apparatus and a second wireless communication apparatus that directly perform communication with each other through a radio channel, and quality information that is information associated with quality of the communication;
a decision process of deciding an algorithm for determining an environment of the radio channel with reference to the distance information; and
a determination process of determining the environment of the radio channel by using the quality information and the algorithm decided in the decision means process.

14. An information processing method comprising:
obtaining distance information that indicates a distance between a first wireless communication apparatus and a second wireless communication apparatus that directly perform communication with each other through a radio channel, and quality information that is information associated with quality of the communication;
deciding an algorithm for determining an environment of the radio channel with reference to the distance information; and
determining the environment of the radio channel by using the quality information and the decided algorithm.

15. A computer-readable non-transitory storage medium storing a program for causing a computer to function as the information processing apparatus according to claim 1, the program causing the computer to carry out the obtaining process, the decision process, and the determination process.
